(19) United States
(12) Patent Application Publication
(10) Pub. No.: US 2007/0078967 A1
(43) Pub. Date: Apr. 5, 2007

(54) Guard tour event notification system

(75) Inventors: Michael B. O'Flaherty, Streetsboro, OH (US); Barry J. Markwitz, Solon, OH (US)

Correspondence Address: James A. Hudak, Esq., Suite #304, 29425 Chagrin Blvd., Cleveland, OH, 44122-4602, US

(73) Assignee: TimeKeeping Systems, Inc.

(21) Appl. No.: 11/240,062

(22) Filed: Oct. 3, 2005

(51) Int. Cl. G06F 15/173

(52) U.S. Cl. 709/224

(57) ABSTRACT

A system is disclosed that notifies a specific person or group of persons, as soon as possible, when a designated event or combination of events related to a guard tour occurs. The system utilizes configurable notification parameters related to each defined event in the guard tour system. Each event is associated with a prioritized, user defined list of addressees to be notified if and when an event occurs. Each addressee entry in the list contains or is associated with notification profiles that include the addressee names, the addressee contact type (telephone, fax, pager, e-mail, or the like), the notification address (telephone number, fax number, pager number, e-mail address, or the like) and the content of the message to be sent if and when the event occurs. The notification is first sent to the first addressee in the list; the notification is then sent to the second addressee in the list, and so on. If the end of the list is reached and there have been unsuccessful attempts to deliver notifications to addressees, the process repeats until all notifications have been successfully delivered or a predetermined period of time has expired.

### TECHNICAL FIELD

The present invention relates, in general, to a notification system for a guard tour system and, more particularly, to a guard tour event notification system that automatically notifies a specific person or group of persons as soon as possible when a designated event or combination of events related to a guard tour occurs.

### BACKGROUND ART

Various automated systems exist to track and assist security officers in the performance of their duties. These systems typically gather time stamped data as to the identification of the officer, the physical location of the officer, and the incidents that occur during a guard tour. This information or data is utilized by the automated systems to determine whether the officer performed assigned duties at the proper time and/or in the proper sequence, and to document incidents encountered by the officer during the performance of his assigned duties. All of this information is then used to create reports that can be printed or viewed on demand. These reports are typically printed and later analyzed for various purposes by management, supervisors and others.

To gather the information or data, an officer usually reads a device, such as a bar code, touch button, or magnetic strip, or RFID tag. At least one of these devices identifies the officer; other devices are physically located at checkpoints the officer is required to visit during a guard tour; still other devices are carried by the officer and read to indicate various incidents or incident types encountered by the officer while on tour. When the officer reads any of these devices, the reader stores an identifier unique to the officer, the location, and/or the incident, along with a time stamp. Other methods can be utilized, such as methods that determine the officer's location and time without the use of physical checkpoints, and methods that use data that are physically entered by the officer instead of a physical device to indicate the officer's identity and incidents encountered by the officer during a guard tour. Regardless of the manner in which the system operates, all of the systems gather time stamped data that include the officer's identity, location, and incidents encountered by the officer during a guard tour.

A guard tour system user who typically works in a managerial or supervisory level configures the data that distinguish normal data from events. In most cases incidents are always events, but depending on the criteria used, time stamped officer and location data can also qualify as events. Parameters such as time windows (periods of time) during which a given location must be visited by the officer, time windows during which an officer must log in for work, or the fact that an officer has logged in for work, and the like, form the configurable criteria upon which events are based within the guard tour system.

It is often desirable or necessary for management, supervisors, and others to be alerted as soon as possible when specific events related to the guard tour are encountered. Examples of such events are the following:
1) An inmate's cell is to be visited every fifteen minutes by a prison guard during a suicide watch. If such a visit is more than one minute late, supervisory and/or managerial staff members need to be notified immediately.
2) Police in a high crime area want to be notified immediately if security officers at a specific facility within the area witness any suspicious activity.
3) A manager or supervisor wants to be notified immediately if one of the officers does not report for work on time or misses an assigned checkpoint.
   Although reports produced by presently available automated guard tour systems may contain the information required in these circumstances, they do not provide timely notification of events to the specific individuals who require same. This is particularly true when those individuals are visiting locations where access to the guard tour system is unavailable, as is typically the case in correctional institutions.

In view of the foregoing, it has become desirable to develop a guard tour event notification system that automatically notifies a specific person or group of persons as soon as possible, regardless of their location, when a designated event or combination of events related to a guard tour occurs.

### SUMMARY OF THE INVENTION

The present invention solves the problems associated with prior art guard tour notification systems, and other problems, by notifying a specific person or group of persons as soon as possible, regardless of their location, when a designated event or combination of events related to a guard tour occurs. To accomplish the foregoing, the present invention utilizes additional configurable notification parameters related to each defined event in the automated guard tour system. Each event is associated with a prioritized, user defined list of addressees to be notified if and when the event occurs. If the list is empty, no notifications will occur. Each addressee entry in the list contains or is associated with notification profiles that include the addressee names, the addressee contact type (such as telephone, fax, pager, e-mail, or the like), the notification address (such as telephone number, fax number, pager number, e-mail address, or the like), and the content of the message to be sent if and when the event occurs. The notification is first sent to the first addressee in the list; the notification is then sent to the second addressee in the list, and so on. If the end of the list is reached and there have been unsuccessful attempts to deliver notifications to addressees via devices that do not store messages, such as telephones, the process repeats until all notifications via such devices have been successfully delivered, or until the process is terminated automatically or manually. Automatic termination of the process can be based on elapsed time, the number contact attempts, the number of successful contacts, or other appropriate parameters. Manual termination of the process is password protected for use by managers or other authorized persons.

In other embodiments of the present invention, addressee notification profiles may include additional configurable parameters indicating the language in which the message will be delivered, the course of action to be taken if a message is not successfully delivered, whether an acknowledgement is required, the period of time to wait before trying again if message delivery is unsuccessful, and the number of times message delivery to a given addressee should be retried, or the like.

Successfully delivered notifications are those notifications that are acknowledged by the addressee. When notifications are sent via devices that do not store messages, such as telephones, acknowledgement by the addressee can occur immediately. To acknowledge the notification, the present invention can utilize voice recognition technology and request the addressee to speak, or alternatively, the addressee can be requested to enter a password via the telephone keypad.

When notifications are sent to devices that store messages such as voice mail, fax, e-mail and pagers, acknowledgement by the addressee can occur only after the addressee receives the message. Such notifications, in addition to the guard tour system event message, contain instructions for acknowledging the notification. For example, a voice mail notification could specify a telephone number to call for notification acknowledgement and/or an e-mail address to which an acknowledgement can be sent. Such methods can employ a password that must be supplied by the addressee when acknowledging the message. The present invention monitors at least one communication means, such as a telephone line and/or e-mail address for incoming notification acknowledgements, verifies the authenticity of the acknowledgement, and either limits or ceases ongoing notifications. It should be noted that all notifications and acknowledgements are logged for later reporting and other uses.

Notifications can be either active or retired. Active notifications are those whose receipt has not been acknowledged by all required recipients, and for which a configurable time period has not elapsed since the notification was sent. For example, if a notification is delivered by e-mail, the notification remains active until the addressee acknowledges receipt of the notification by means indicated in the notification e-mail. The present invention monitors active notifications, applies acknowledgements to the active notifications, and retires the active notifications when either all addressees have acknowledged the notification or when a configurable period of time has elapsed since the notification was sent. After the notification has been retired, the system issues a reply to any addressee attempting to acknowledge the notification.

In another embodiment of the present invention, the system incorporates a configurable parameter that “tells” the system how many notifications of the event must have their receipt acknowledged before ceasing further notifications and retiring the notifications. The number of notifications is a number between one and the number of addressees in the list to be notified of this event. In this manner it is possible to retire the notification as soon as anyone on the list has received it.

In a further embodiment, a configurable parameter determines whether notification is required or optional for each addressee. Notifications are not sent to addressees that are designated as being optional if any other addressee in the list has previously acknowledged receipt of the same notification. Notifications are not retired until every addressee designated as required has acknowledged receipt of the notification, or the configurable time period has elapsed since the notification was sent.

In still another embodiment, all addressees are notified simultaneously, rather than in priority order, by means indicated in the addressee's notification profile.

In a still further embodiment, after a successful notification acknowledgement, an addressee receiving a notification can forward the notification to other addressees that are not necessarily on the contact list by using voice commands, telephone keypad commands, or e-mail, depending on the method of delivery.

### BRIEF DESCRIPTION OF THE DRAWINGS

FIGS. 1A and 1B are a flow chart of the program that is executed by the event notification system of the present invention.

FIG. 2 is a flow chart of the program that is executed by the notify addressee logic utilized in FIG. 1.

### DESCRIPTION OF THE PREFERRED EMBODIMENT

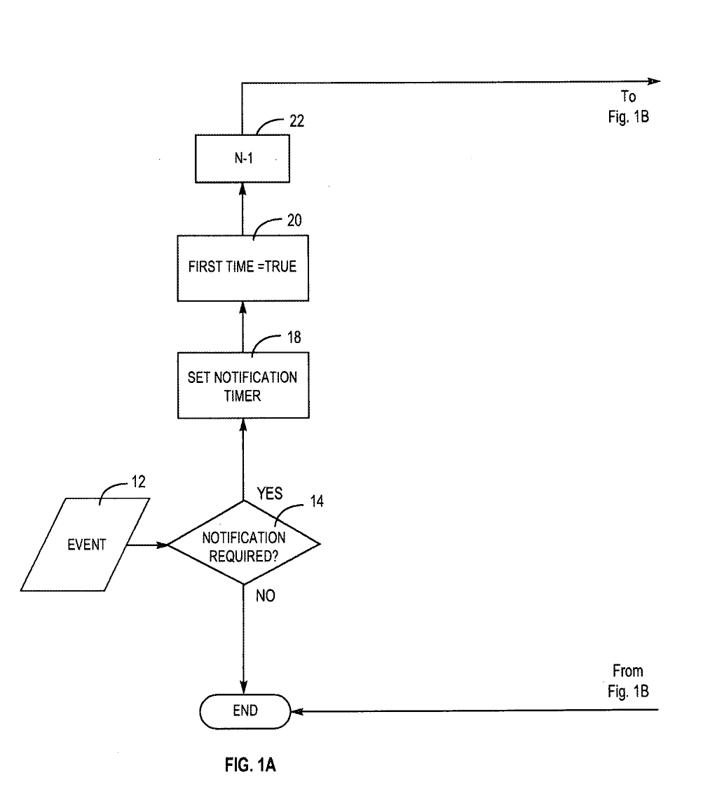

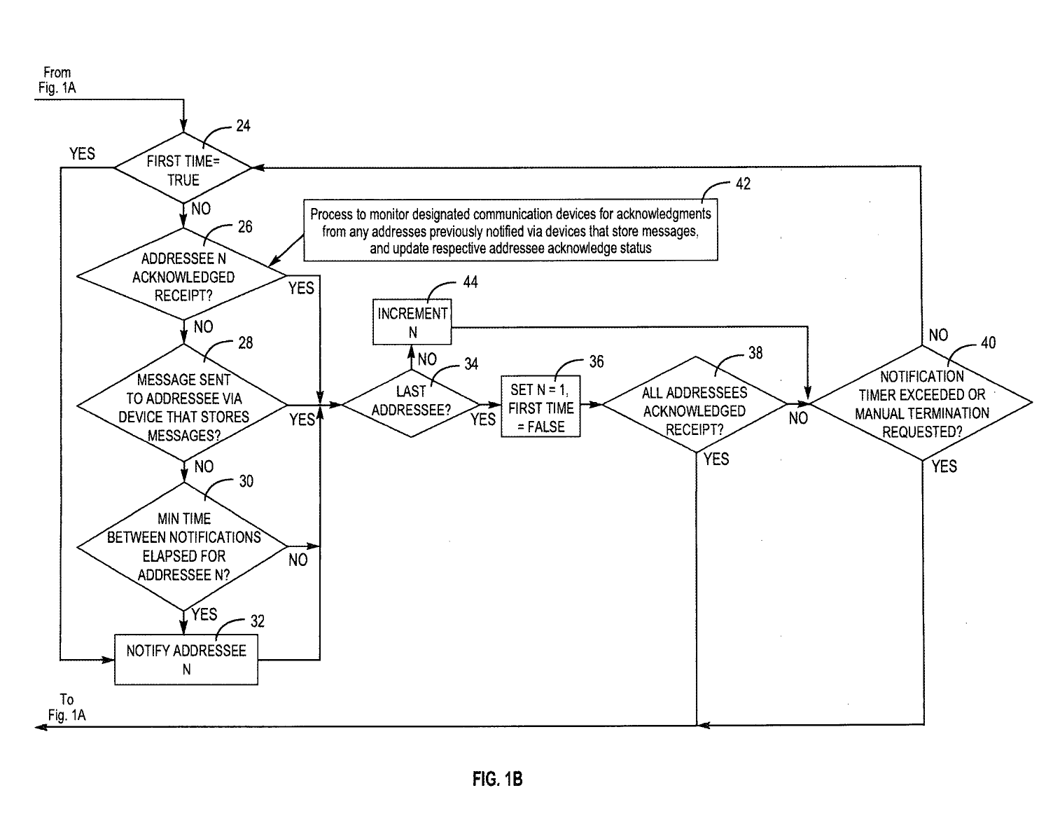

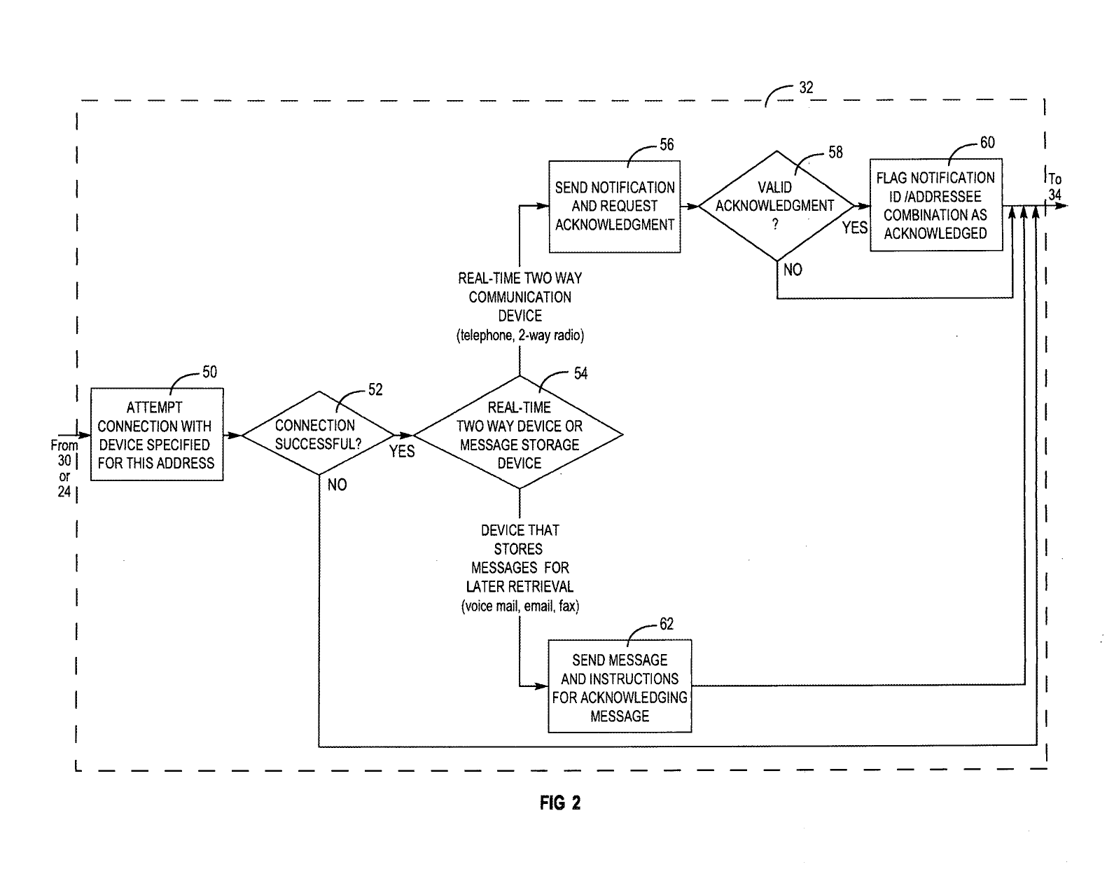

Referring now to the Figures where the illustrations are for the purpose of describing the preferred embodiment of the present invention and are not intended to limit the invention described herein, FIGS. 1A and 1B are a flow chart of the logic that is executed by the event notification system 10 of the present invention. In this system 10, when an event referred to in block 12 occurs, a determination is made in block 14 as to whether notification of the event to a list of addressees is required. If notification of the event to a list of addressees is not required, the logic is ended, as shown in block 16. If notification of the event to a list of addressees is required, a notification timer is set to a predetermined duration of time during which the system 10 will attempt to notify addressees in the list of addressees of the event, in block 18. In addition, a first time indicator is set to TRUE in block 20 to indicate that no attempt has yet been made to notify at least one addressee of this event. Also, the addressee number is set to 1, i.e., indicating the first addressee in the list of addressees to be notified of the event, in block 22. A check is then made in block 24 as to whether the first time indicator is set to TRUE. Since the first time indicator has been set to TRUE, the logic proceeds to block 32 where an attempt to notify the first addressee is made according to the logic shown in FIG. 2.

Referring now to FIG. 2, a flow chart of the logic executed within block 32 in FIG. 1B is shown. In FIG. 2, the incoming arrow into block 32 is from block 30 or from block 24 in FIG. 1B, and the outgoing arrow from block 32 goes to block 34 in FIG. 1B. In block 50 an attempt is made to establish a connection with a previously specified communication device associated with the first addressee. A check is then made in block 52 as to whether the connection attempt made in block 50 was successful and communication has thereby been established with the previously specified communication device associated the first addressee, by which the first addressee is to receive notification of the event. If no connection has been established with the previously specified device associated with the first addressee, the logic causes the system 10 to proceed to block 34 on FIG. 1. If a connection has been established with the previously specified device associated with the first addressee, a determination is made in block 54 in FIG. 2 as to whether the previously specified device associated with the first addressee is a real-time two-way communication device. If the previously specified device associated with the first addressee is a real-time two-way communication device, such as a telephone or two-way radio, notification of the event and a request for acknowledgement is sent to the first addressee, as shown in block 56. Whether a valid acknowledgement of notification of the event has been received from the first addressee is verified in block 58. If a valid acknowledgement of notification of the event has been received from the first addressee, the notification identification and addressee combination is “flagged” as being acknowledged in block 60 and the program proceeds to block 34 in FIG. 1B. If a valid acknowledgement of notification of the event has not been received from the first addressee, the logic proceeds to block 34 in FIG. 1B without changing the acknowledgement status of the notification for the first addressee. If it is determined in block 54 that the previously specified device associated with the first addressee is a device that stores messages for later retrieval by the addressee, such as voice mail, e-mail, or fax, the message regarding the event, along with instructions for acknowledging the notification, are sent to the previously specified device associated with the first addressee in block 62. The logic then proceeds to block 34 in FIG. 1B.

Referring again to FIG. 1B, a determination is made in block 34 as to whether the first addressee is the only addressee, and thus the last addressee, in the list of addressees to be notified of the event. If the first addressee is the only addressee, and thus the last addressee, to be notified of the event, the logic proceeds to block 36 where the addressee number is again set to 1 and the first time flag is set to FALSE. Verification is then made in block 38 as to whether all addressees have acknowledged receipt of notification of the event. If the first addressee, who is also the only addressee, has acknowledged receipt of notification of the event, the logic is ended in block 16. If the first addressee, who is also the only addressee, has not acknowledged receipt of notification of the event, a check is made in block 40 as to whether the predetermined duration of time during which the system 10 will attempt to notify addressees in the list of addressees of the event has expired, or whether a manual termination of the notification process has been requested. If the predetermined duration of time during which the system 10 will attempt to notify addressees in the list of addressees of the event has not expired and a manual termination of the notification process has not been requested, the logic reverts back to block 24, where a check is then made as to whether the first time indicator is set to TRUE. Since the first time indicator has been set to FALSE, a determination is then made in block 26 as to whether the first addressee has acknowledged receipt of notification of the event. The determination made in block 26 utilizes addressee acknowledgement information that is updated as acknowledgements are received from addressees that were notified via devices that store messages, by the process shown in block 42. The process shown in block 42 monitors at least one predefined communication means, such as a telephone line or e-mail address, for incoming notification acknowledgements, and verifies the authenticity of such acknowledgement. If, in block 32, the first addressee had previously been sent a notification of the event by a device that stores messages for later retrieval by the addressee, such as voice mail, e-mail, or fax, and if the first addressee has since acknowledged receipt of the message, a determination is then made in block 34 as to whether the first addressee is the only addressee, and thus the last addressee, in the list of addressees to be notified of the event. Since the first addressee is the only addressee, and thus, the last addressee, to be notified of the event, the logic proceeds to block 36 where the addressee number is again set to 1 and the first time flag is set to FALSE. Verification is then made in block 38 as to whether all addressees have acknowledged receipt of notification of the event. Since the first addressee, who is the only addressee, has acknowledged receipt of notification of the event, the logic is ended in block 16.

If, in block 32, the first addressee, who is the only addressee, had previously been sent a notification of the event by a device that stores messages for later retrieval by the addressee, such as voice mail, e-mail, or fax, and if the first addressee has not acknowledged receipt of the message, a determination is then made in block 28 as to whether a message has been sent to the first addressee via a device that stores messages for later retrieval by the addressee, such as voice mail, e-mail, or fax. Since a message has been sent to the first addressee via a device that stores messages for later retrieval by the addressee, such as voice mail, e-mail or fax, a determination is made in block 34 as to whether the first addressee is the only addressee, and thus the last addressee, in the list of addressees to be notified of the event. Since the first addressee is the only addressee, and thus the last addressee, to be notified of the event, the logic proceeds to block 36 where the addressee number is again set to 1 and the first time flag is again set to FALSE. Verification is then made in block 38 as to whether all addressees have acknowledged receipt of notification of the event. Since the first addressee, who is the only addressee, has not acknowledged receipt of notification of the event, a check is made in block 40 as to whether the predetermined duration of time during which the system 10 will attempt to notify addressees in the list of addressees to be notified of the event has expired, or whether a manual termination of the notification process has been requested. If the predetermined duration of time during which the system 10 will attempt to notify addressees in the list of addressees has not expired and a manual termination of the notification process has not been requested, the logic will continue until the first addressee acknowledges receipt of notification of the event or until the predetermined duration of time during which the system 10 will attempt to notify the addressees in the list has expired or a manual termination of the notification process has been requested, at which time the logic will end, as shown in block 16.

If, in block 32, the first addressee, who is the only addressee, had previously been sent a notification of the event by a real-time two-way communication device, such as a telephone or a two-way radio, and if the first addressee has not provided a valid acknowledgment of being notified of the event, a determination is made in block 28 as to whether a message has been sent to the first addressee via a device that stores messages for later retrieval by the addressee, such as voice mail, e-mail, or fax. Since a message has not been sent to the first addressee via a device that stores messages for later retrieval by the addressee, such as voice mail, e-mail, or fax, a determination is made in block 30 as to whether the first time flag is set to TRUE or whether the minimum time between notification attempts has expired. If the minimum time between notification attempts has not expired, a determination is then made in block 34 as to whether the first addressee is the only addressee, and thus the last addressee, in the list of addressees to be notified of the event. Since the first addressee is the only addressee, and thus the last addressee, to be notified of the event, the logic proceeds to block 36 where the addressee number is again set to 1 and the first time flag is set to FALSE. Verification is then made in block 38 as to whether all addressees have acknowledged receipt of notification of the event. Since the first addressee, who is the only addressee, has not acknowledged receipt of notification of the event, a check is made in block 40 as to whether the predetermined duration of time of time during which the system 10 will attempt to notify addressees in the list of addressees to be notified of the event has expired, or whether a manual termination of the notification process has not been requested. If the predetermined duration of time during which the system 10 will attempt to notify addressees in the list of addressees has not expired and a manual termination of the notification process has not been requested, the logic will continue until the first addressee acknowledges receipt of notification of the event or until the predetermined duration of time during which the system 10 will attempt to notify addressees in the list has expired or a manual termination of the notification process has been requested, at which time the program will end, as shown in block 16.

If, in block 32, the first addressee, who is the only addressee, had previously been sent a notification of the event by a real-time two-way communication device, such as a telephone or a two-way radio, and if the first addressee has not provided a valid acknowledgement of receipt of being notified of the event, a determination is made in block 28 as to whether a message has been sent to the first addressee via a device that stores messages for later retrieval by the addressee, such as voice mail, e-mail, or fax. Since a message has not been sent to the first addressee via a device that stores messages for later retrieval by the addressee, such as voice mail, e-mail, or fax, a determination is made in block 30 as to whether the minimum time between notification attempts has expired. If the minimum time between notification attempts has expired, another attempt to notify the first addressee is made in block 32, according to the logic shown in FIG. 2. A determination is then made in block 34 as to whether the first addressee is the only addressee, and thus the last addressee, in the list of addressees to be notified of the event. Since the first addressee is the only addressee, and thus the last addressee, to be notified of the event, the logic proceeds to block 36 where the addressee number is again set to 1 and the first time flag is again set to FALSE. Verification is then made in block 38 as to whether all addressees have acknowledged receipt of notification of the event. Since the first addressee, who is the only addressee, has not acknowledged receipt of notification of the event, a check is made in block 40 as to whether the predetermined duration of time during which the system 10 will attempt to notify addressees in the list of addressees to be notified of the event has expired, or whether a manual termination of the notification process has been requested. If the predetermined duration of time during which the system 10 will attempt to notify addressees in the list of addressees has not expired and a manual termination of the notification process has not been requested, the logic will continue until the first addressee acknowledges receipt of notification of the event or until the predetermined duration of time during which the system 10 will attempt to notify addressees in the list has expired or a manual termination of the notification process has been requested at which time the logic will end, as shown in block 16.

If it is determined in block 34 that the first addressee is not the last addressee in the list of addressees to be notified of the event, the number of the addressee is incremented by 1 in block 42 and a check is made in block 40 as to whether the predetermined duration of time during which the system 10 will attempt to notify addressees in the list of addressees to be notified of the event has expired. Since the predetermined duration of time during which the system 10 will attempt to notify addressees has not expired, a check is then made in block 24 as to whether the first time indicator is set to TRUE. Since the first time indicator is set to TRUE, the logic then proceeds to notify the second addressee in the list of addressees to be notified of the event in the same manner as previously described for notifying the first addressee in the list. The foregoing process repeats incrementally and sequentially for each addressee on the list to be notified of the event until a valid acknowledgement of notification of the event has been received from all addressees or the predetermined duration of time during which the system 10 will attempt to notify addressees in the list of addressees has expired or a manual termination of the notification process has been requested.

It should be noted that all or part of the communication between the notification system of the present invention and addressees can be handled by intermediate computers, such as those connected to the Internet using technologies like VoiceXML.

It should be further noted that even though the previous discussion has been directed to a notification system for a guard tour system, its application is not limited to such a guard tour system and can be applied to any type of system where a person inspects or visits locations on a periodic basis and transmits his or her findings when an exceptional condition has occurred at a particular location. In essence, this notification system of the present invention can be utilized for any type of periodic inspection procedures of one or more locations.

Certain modifications and improvements will occur to those skilled in the art upon reading the foregoing. It is understood that all such modifications and improvements have been deleted herein for the sake of conciseness and readability, but are properly within the scope of the following claims.

We claim:

1) A method of monitoring data and notifying an addressee of an event associated with the data comprising the steps of:
a) monitoring data including one or more indicators indicating one or more events associated with said data;
b) detecting said one or more events associated with said data; and
c) sending a message indicating that said one or more of said events has been detected, said message being sent to an addressee to be notified of said one or more events.

2) The method as defined in claim 1 further including, after step c), the step of continuing to send said message to said addressee until the occurrence of a predetermined event.

3) The method as defined in claim 2 wherein said predetermined event is an acknowledgement of receipt of said message by said addressee.

4) The method as defined in claim 2 wherein said predetermined event is the expiration of a predetermined period of time for the sending of said message to said addressee.

5) The method as defined in claim 1 wherein said message is sent to an addressee via a real-time two-way communication device.

6) The method of defined in claim 1 wherein said message is sent to an addressee via a device that stores voice messages.

7) The method as defined in claim 1 wherein said message is sent to an addressee via a device that stores messages.

8) The method as defined in claim 1 wherein said message is sent to a list of addressees to be notified of said one or more events.

9) The method as defined in claim 8 wherein said message is sent sequentially to addressees in said list of addressees.

10) A method of sending a message acknowledging receipt of notification of one or more events associated with data comprising:
a) transmitting the message via a real-time two-way communication device to an addressee to be notified of one or more events associated with said data;
b) requesting said addressee to which said message was transmitted to acknowledge receipt of said message;
c) determining whether a valid acknowledgement has been received from said addressee to which said message was transmitted; and
d) providing an indicator identifying that the message was acknowledged by said addressee to which said message was transmitted.

11) A method of sending a message acknowledging receipt of notification of one or more events associated with data comprising the steps of:
a) transmitting the message and instructions for acknowledging said message via a device that stores messages to an addressee to be notified of one or more events associated with said data;
b) providing an indicator identifying that the message was sent and not acknowledged by said addressee to which said message was transmitted;
c) providing a means by which said addressee can acknowledge receipt of said message after retrieval of said message from said device that stores messages; and
d) providing an indicator that the message was acknowledged by said addressee to which said message was transmitted.

12) A method of monitoring data and notifying an addressee of an event associated with the data comprising the steps of:
a) monitoring data including one or more indicators indicating one or more events associated with said data;
b) detecting said one or more events associated with said data;
c) sending a message indicating that said one or more of said events has been detected, said message being transmitted via a real-time two-way communication device to an addressee to be notified of said one or more events;
d) requesting said addressee to which said message was transmitted to acknowledge receipt of said message;
e) determining whether a valid acknowledgement has been received from said addressee to which said message was transmitted; and
f) providing an indicator identifying that said message was acknowledged by said addressee to which said message was transmitted.

13) A method of monitoring data and notifying an addressee of an event associated with the data comprising the steps of:
a) monitoring data including one or more indicators indicating one or more events associated with said data;
b) detecting said one or more events associated with said data;
c) sending a message indicating that said one or more of said events has been detected, said message being transmitted via a device that stores messages to an addressee to be notified of said one or more events and including instructions for acknowledging said message by said addressee;
d) providing an indicator identifying that said message was sent and not acknowledged by said addressee;
e) providing a means by which said addressee can acknowledge receipt of said message after retrieval of said message from said device that stores messages; and
f) providing an indicator that said message was acknowledged by said addressee to which said message was transmitted.
